(19) United States
(12) Patent Application Publication
(10) Pub. No.: US 2004/0166721 A1
(43) Pub. Date: Aug. 26, 2004

(54) Video slot device

(76) Inventors: Tomomi Hara, Kanagawa (JP); Toshiya Shigeta, Kanagawa (JP)

Correspondence Address: FISH & RICHARDSON P.C., 1425 K STREET, N.W., 11TH FLOOR, WASHINGTON, DC, 20005-3500, US

(21) Appl. No.: 10/481,022

(22) PCT Filed: Nov. 13, 2001
(86) PCT No.: PCT/JP01/09913

(51) Int. Cl. H01R 13/64

(52) U.S. Cl. 439/377

(57) ABSTRACT

A slot apparatus for video capable of holding unit boards has a main board 3 and a plurality of connectors 4 provided on the main board 3. A slot part 5 is provided at a position facing the connectors 4. A plurality of unit guides 6 are provided at spacings in the slot part 5. A plurality of unit boards 10 are inserted into the slot part 5 along the unit guides 6. The unit boards 10 are connected to the connectors 4, respectively. The unit guides 6 are detachably provided.

### TECHNICAL FIELD

The present invention relates to a slot apparatus for video that is capable of holding unit boards.

### BACKGROUND ART

A video rack is placed in a studio such as a broadcasting studio or a production studio. The video rack houses a slot apparatus for video and so forth. The slot apparatus for video has a main board and a power unit in a chassis. The main board is provided with a connector for electrically connecting together the main board and the power unit and also provided with a plurality of unit connectors for electrically connecting together the main board and unit boards. Each unit connector connects one unit board to the main board.

In the chassis, a slot part is provided forward of the unit connectors provided on the main board for holding unit boards connected to the respective unit connectors. The slot part is provided with a plurality of unit guides spaced by the width of each unit board to facilitate connection of the unit boards to the unit connectors. The unit guides form a plurality of divided slots in the slot part. The unit boards are inserted into the divided slots while being guided by the unit guides, and connected to the unit connectors.

However, in a case where a plurality of unit guides are spaced by the width of only one type of unit board, a unit board expanded in width cannot be inserted into any of the divided slots. In other words, the width of unit boards insertable into the divided slots is limited to only one size.

The present invention was made in view of the above-described problems with the prior art, and an object of the present invention is to provide a slot apparatus for video that is capable of holding unit boards of various widths.

### DISCLOSURE OF INVENTION

The present invention provides a slot apparatus for video having a main board and a plurality of connectors provided on the main board. A slot part is provided at a position facing the connectors. A plurality of unit guides are provided at spacings in the slot part. A plurality of unit boards are inserted into the slot part along the unit guides. The unit boards are connected to the connectors, respectively.

The unit guides may be detachably provided.

Further, the unit guides may be provided in such a manner that the spacings are variable.

The slot part may have a plurality of divided slots formed therein by the unit guides, so that the unit boards are inserted into the divided slots, respectively.

The number of the divided slots formed in the slot part may be five.

The divided slots may be made expandable by varying the spacings of the unit guides.

One of the connectors may be a power unit connector.

Further, the slot part may be provided with a power unit, which is connected to the power unit connector.

### BRIEF DESCRIPTION OF THE DRAWINGS

FIG. 1 is a fragmentary perspective view showing an embodiment of the slot apparatus for video according to the present invention.

FIG. 2(a) is a plan view showing the embodiment.

FIG. 2(b) is a front view showing the embodiment.

FIG. 3(a) is a plan view showing the embodiment.

FIG. 3(b) is a front view showing the embodiment.

FIG. 4(a) is a side view showing an example of a unit applicable to the embodiment.

FIG. 4(b) is a plan view showing the example of the unit applicable to the embodiment.

FIG. 4(c) is a front view showing the example of the unit applicable to the embodiment.

FIG. 5(a) is a plan view showing the embodiment.

FIG. 5(b) is a front view showing the embodiment.

### EMBODIMENTS OF THE INVENTION

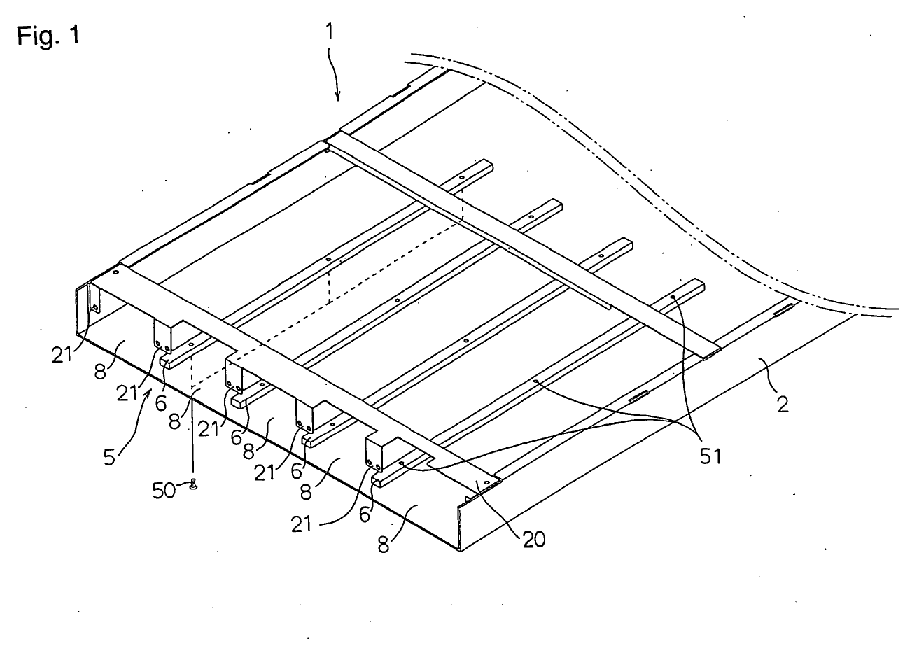

An embodiment of the slot apparatus for video according to the present invention will be described below with reference to the accompanying drawings. In FIGS. 1 to 3, reference numeral 1 denotes a slot apparatus for video according to the present invention. The slot apparatus 1 for video comprises mainly a main board 3, a plurality of connectors 4, a slot part 5, a plurality of unit guides 6, and a power unit 7, which are provided in a rectangular chassis 2.

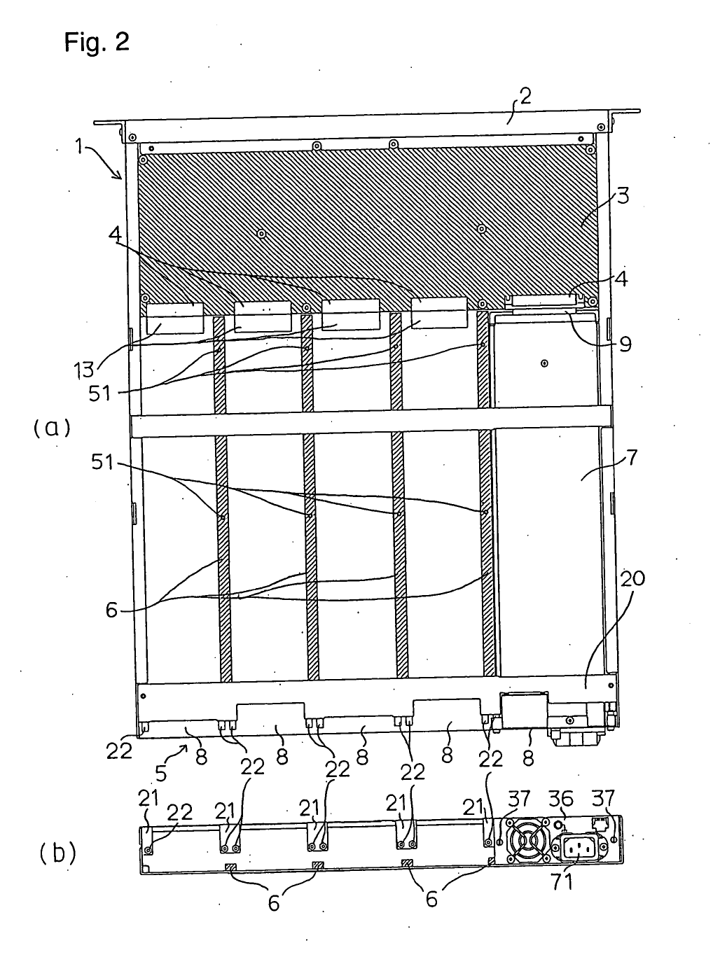

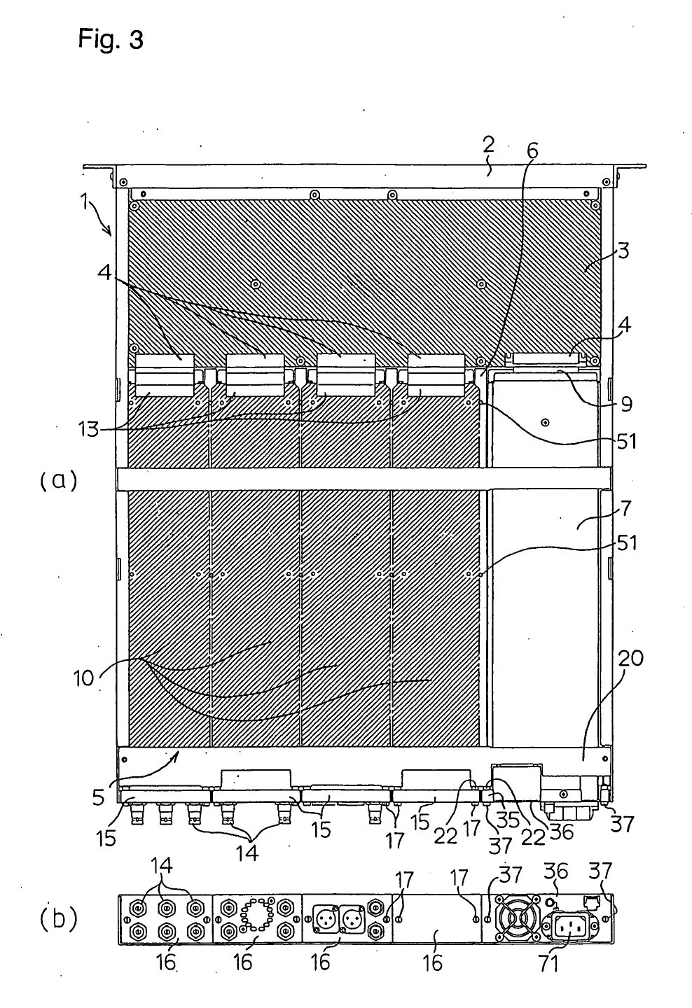

The main board 3 is provided in the inner part [in the upper part in FIGS. 2(a) and 3(a)] of the chassis 2. The main board 3 has a plurality of connectors 4 provided on the front side thereof [on the lower side thereof in FIGS. 2(a) and 3(a)] at fixed spacings in the lateral direction of the chassis 2 [in the horizontal direction in FIGS. 2(a) and 3(a)]. In the illustrated example, five connectors 4 are provided at fixed spacings. Of the five connectors 4, the rightmost connector 4 is a power unit connector, and the remaining four connectors 4 are unit board connectors. A slot part 5 is provided in the chassis 2 at a position facing the connectors 4.

The slot part 5 is provided with a plurality of unit guides 6 of continuous length disposed along the longitudinal direction of the chassis 2 [in the vertical direction in FIGS. 2(a) and 3(a)] at fixed spacings in the lateral direction of the chassis 2. More specifically, the slot part 5 in the illustrated example is provided with four unit guides 6. Each unit guide 6 is provided between two connectors 4 adjacent to each other. The four unit guides 6 form five divided slots 8 in the slot part 5. One connector 4 is disposed in each divided slot 8.

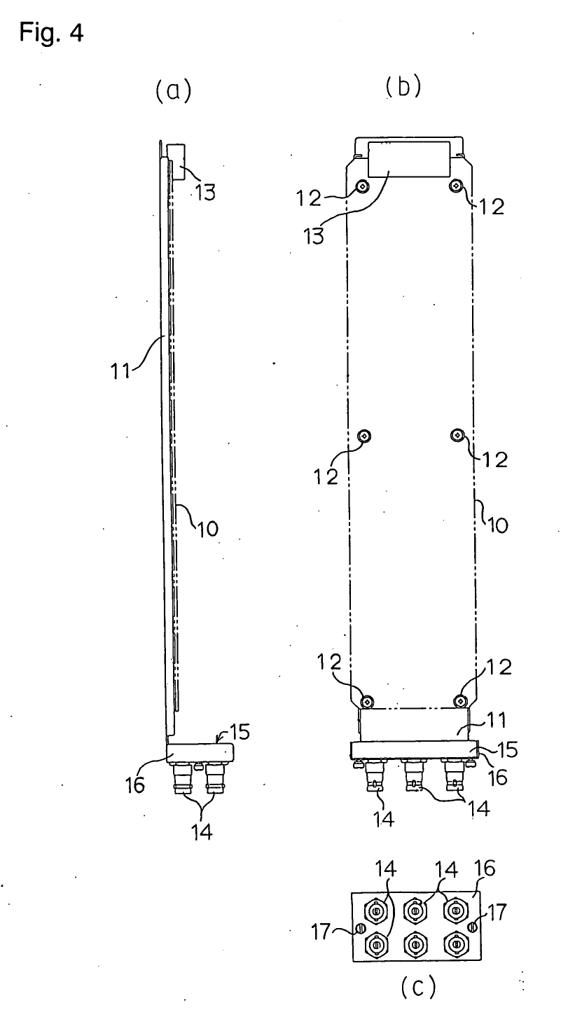

Of the five divided slots 8 formed in the slot part 5, the left four divided slots 8 have unit boards 10 inserted therein along the unit guides 6. As shown in FIG. 4, each unit board 10 is provided on a unit 11 of continuous length and secured thereto with screws 12 or the like. Accordingly, the unit boards 10 are inserted into the divided slots 8 in the state of being mounted on the respective units 11.

The unit boards 10 are connected to the unit board connectors 4, respectively, thereby being electrically connected to the main board 3. More specifically, each unit board 10 is provided with a connector 13 for connection at one end thereof [at the upper end thereof in FIGS. 4(a) and 4(b)]. Each unit board 10 is electrically connected to the main board 3 by connecting the connector 13 to the corresponding unit board connector 4.

A connecting plate 15 having external connection connectors 14 and so forth is stood at one end of the unit 11 [at the lower end thereof in FIGS. 4(a) and 4(b)]. A unit panel 16 is secured to the surface of the connecting plate 15 with screws 17. The external connection connectors 14 and so forth project from the unit panel 16. The external connection connectors 14 and so forth are electrically connected to the unit board 10 through the unit 11.

A support plate 20 is provided on the top of the front side [lower side in FIGS. 2(a) and 3(a)] of the chassis 2 along the lateral direction of the chassis 2 [along the horizontal direction in FIGS. 2(a) and 3(a)]. A plurality of securing plates 21 are provided to suspend from one end [lower end in FIGS. 2(a) and 3(a)] of the support plate 20. The securing plates 21 are provided at the same spacings as those of the unit guides 6. Each securing plate 21 is provided with supports 22 having threaded grooves. By engaging the screws 17 into the threaded grooves of the supports 22 through the unit panel 16, each unit 11 is secured to the chassis 2 in the state of being inserted into a divided slot 8.

Of the five divided slots 8 formed in the slot part 5, the rightmost divided slot 8 is provided with a power unit 7. A connector 9 for connection is provided at one end [upper end in FIGS. 2(a) and 3(a)] of the power unit 7. The power unit 7 is electrically connected to the main board 3 by connecting the connector 9 to the power unit connector 4.

A connecting plate 35 having a plug socket part 71 and so forth is stood at the other end [lower end in FIGS. 2(a) and 3(a)]. A unit panel 36 is attached to the surface of the connecting plate 35 with screws 37. The plug socket part 71 and so forth project from the unit panel 36. The plug socket part 71 and so forth are electrically connected to the power unit 7. The power unit 7 is secured to the chassis 2 in the state of being inserted in the associated divided slot 8 by engaging the screws 37 into the threaded grooves of the supports 22, which are provided on the securing plates 21, through the unit panel 36.

Next, the unit guides 6, which are a characteristic feature of the present invention, will be described. As has been stated above, the four unit guides 6 form five divided slots 8 in the slot part 5. The unit guides 6 are detachably provided in the slot part 5. In the illustrated example, each unit guide 6 is detachably provided in the slot part 5 with three screws 50. More specifically, as shown in FIG. 1, each unit guide 6 has threaded grooves 51 formed at three positions, respectively, i.e. positions near both ends of the unit guide 6 and a position in the center thereof. The screws 50 engage into the threaded grooves 51 from the outside of the bottom plate of the chassis 2 through respective holes (not shown) formed in the bottom plate of the chassis 2.

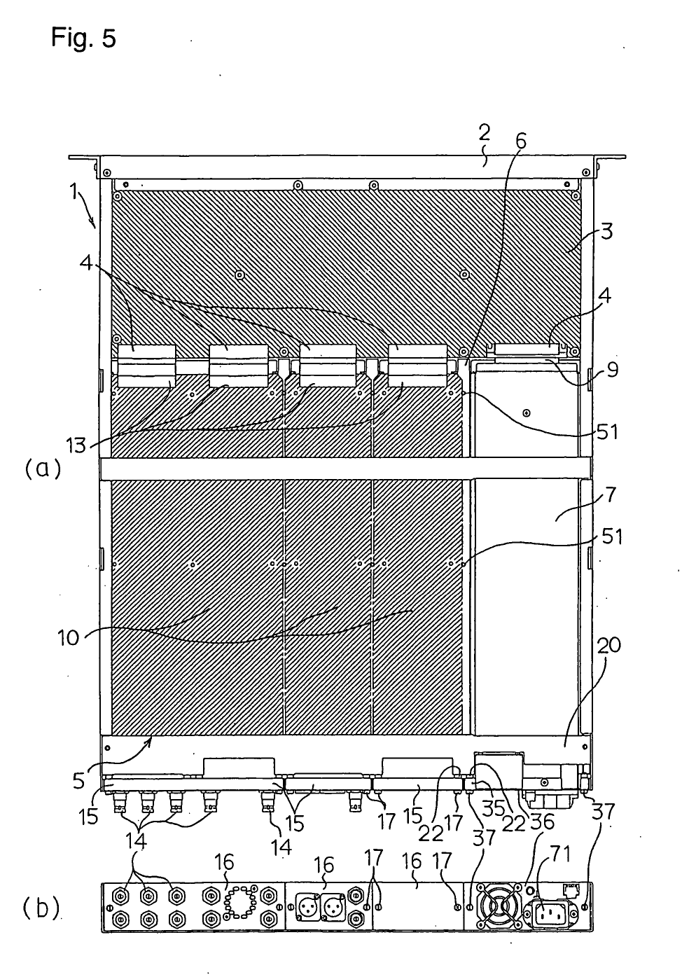

Accordingly, each unit guide 6 can be removed from the slot part 5 by disengaging the screws 50 from the threaded grooves 51. That is, the unit guides 6 are detachably provided so that the above-described spacings are variable. Consequently, the divided slots 8 can be expanded in width by varying the spacings between the unit guides 6. FIG. 5 shows an example in which the leftmost unit guide 6 is removed to provide a divided slot 8 expanded two times the original width. The divided slot 8 expanded to double the original width in this way can receive a unit board twice as wide as the unit boards 10 inserted into other non-expanded divided slots 8. In other words, the width of unit boards insertable into the divided slots 8 is not limited to only one size, but unit boards having other widths, e.g. a two-fold width or a three-fold width, can be inserted into the divided slots 8.

Although in the foregoing embodiment a divided slot 8 is expanded by an integral multiple of the original width, e.g. two or three times wider, by removing one or more unit guides 6, the expansion of divided slots 8 is not necessarily limited to an integral multiple of the original width, but the divided slots 8 can be expanded, for example, 1.5 times or 1.3 times the original width. For instance, the arrangement may be as follows. The bottom plate of the chassis 2 is formed with elongated holes that allow the unit guides 6 to be secured at any positions along the above-described spacing direction (i.e. the lateral direction of the chassis 2), and the screws 50 are engaged into the threaded grooves 51 through the elongated holes. This arrangement allows the layout of each unit guide 6 to be adjusted to any desired position in the lateral direction of the chassis 2. Consequently, the divided slots 8 can be expanded, for example, 1.5 times or 1.3 times the original width. In other words, the width of unit boards insertable into the divided slots 8 is not limited to only one size, but it is possible to insert unit boards of various widths, e.g. a 1.5-fold width or a 1.3-fold width.

1. A slot apparatus for video comprising:
a main board;
a plurality of connectors provided on said main board;
a slot part provided at a position facing said plurality of connectors; and
a plurality of unit guides provided at spacings in said slot part;
wherein a plurality of unit boards are inserted into said slot part along said plurality of unit guides, said unit boards being connected to said plurality of connectors, respectively.

2. A slot apparatus for video according to claim 1, wherein said plurality of unit guides are detachably provided.

3. A slot apparatus for video according to claim 1 or 2, wherein said plurality of unit guides are provided in such a manner that said spacings are variable.

4. A slot apparatus for video according to any one of claims 1 to 3, wherein said slot part has a plurality of divided slots formed therein by said plurality of unit guides, said unit boards being inserted into said divided slots, respectively.

5. A slot apparatus for video according to claim 4, wherein a number of said divided slots formed in said slot part is five.

6. A slot apparatus for video according to claim 4 or 5, wherein said divided slots are expandable by varying said spacings of said plurality of unit guides.

7. A slot apparatus for video according to any one of claims 1 to 6, wherein one of said plurality of connectors is a power unit connector.

8. A slot apparatus for video according to claim 7, wherein said slot part is provided with a power unit, said power unit being connected to said power unit connector.
